(19) United States
(12) Patent Application Publication
(10) Pub. No.: US 2025/0163646 A1
(43) Pub. Date: May 22, 2025

(54) PARTICULATE VINYLAMINE COMPOSITIONS AND METHOD OF MAKING

(71) Applicant: SOLENIS TECHNOLOGIES, L.P., Wilmington, DE (US)

(72) Inventors: Dan Whitfield, Holmfirth (GB); Shantanu P. Nikam, Wilmington, DE (US); Sachin Borkar, Wilmington, DE (US); Matthew Wright, Weddington, NC (US)

(73) Assignee: SOLENIS TECHNOLOGIES, L.P., Wilmington, DE (US)

(21) Appl. No.: 18/954,633

(22) Filed: Nov. 21, 2024

Related U.S. Application Data
(60) Provisional application No. 63/601,850, filed on Nov. 22, 2023.

(51) Int. Cl. D21H 17/34; C08F 26/02; D21H 21/10; D21H 21/18

(52) U.S. Cl. CPC D21H 17/34; C08F 26/02; D21H 21/10; D21H 21/18

(57) ABSTRACT

Provided is a method for the production of vinylcarboxamide-containing polymers in a granular, beaded, powdered, or particulate form and subsequent hydrolysis thereof. The vinylcarboxamide-containing polymers and co-polymers, are precipitated in a granular, beaded, powdered, or particulate form employing an inverse suspension polymerization technique.

### CROSS-REFERENCE TO RELATED APPLICATIONS

This application claims the benefit of U.S. Provisional application No. 63/601,850, filed 22 Nov. 2023, the entire contents of which are hereby incorporated by reference.

### TECHNICAL FIELD

Provided is a method for production of vinyl carboxamide containing polymers in granular, beaded, powdered, or particulate form. The method relates to production of poly(N-vinyl formamide), or its co-polymer employing an inverse suspension polymerization technique followed by the removal of the aqueous medium. The product can then be transported to a customer site for hydrolysis.

### BACKGROUND

Polyvinylamine (PVAM) and its compositions are commonly used in the manufacture of paper, board, or the like. These polymers are typically manufactured through the hydrolysis of polyvinylcarboxamide polymers, such as polyvinylformamide or its copolymers. However, delivering PVAM or PVFA polymers to customers involve high transportation and storage costs due to the large volumes involved. Today, commercial products have actives/solid content generally ranging from about 5 weight % (wt. %) to about 50 wt. %. A solid PVAM/PVFA product would help transport larger quantities of active polymer.

The molecular weight (Mw) of the PVAM backbone was found to be an important parameter for its performance in the manufacture of paper and paperboard. The long backbone provides sufficient dimensions for bonding and linkages between the fiber surfaces. The good formation, bonding ability and excellent dewatering provided by the PVAM polymer are beneficial for their strength properties of the final paper or board.

In general, higher molecular weight PVAMs provide a higher performance boost and faster production. The currently employed polymerization methods are limited in their ability to achieve molecular weights while keeping the reactant residuals low. Current invention allows for production of polymers with higher molecular weight and about 100% solids content. These polymers show excellent de-watering performance and strength properties to the paper when compared to polymers in the prior art. The faster dewatering allows for the energy savings in the dryer section and a faster rate of production.

However, the polymer formulations currently in use have inherent limitations in the form of shelf-life, transportation, and in most cases, molecular weight. In general, it has been found that the higher molecular weight PVAMs provide higher performance boost and faster production speeds.

A higher molecular weight PVAM could have even higher benefits. However, with increasing molecular weight, at optimum reaction solids, the viscosity of the aqueous reaction mixture made with conventional techniques increase rapidly making it difficult to handle. Therefore, in order to achieve higher molecular weights with the conventional techniques, the products need to be produced at progressively lower actives/solid content. Thus, increasing the transportation cost involved with shipping of less concentrated products. This makes the operation inefficient and economically less viable and also increase the carbon footprint associated with the product.

The current method relates to production of poly(N-vinyl formamide), or its co-polymer in a granular, beaded, powdered, or particulate form employing an inverse suspension polymerization technique. The product can then be transported to a customer site where it will be hydrolyzed in solution.

Though PVAM and its compositions are fairly stable, the PVFA polymers tend to be more stable over extended periods of time. Employing an on-site hydrolysis will allow on-demand hydrolysis of more stable PVFA, thus further enhancing the shelf-life of the product.

The present method of providing a precipitated vinylcarboxamide-containing polymer would minimize or eliminate the disadvantages associated with the transportation, molecular weight, and performance issues of current methods.

The present disclosure will hereinafter be described in conjunction with the following drawing figures.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a method for producing a composition containing an N-vinylcarboxamide-containing polymer that includes polymerizing through inverse suspension polymerization, a formulation containing an N-vinylcarboxamide monomer.

The method includes the polymerization of an aqueous solution that includes one or more N-vinylcarboxamide monomer(s) of Formula I;

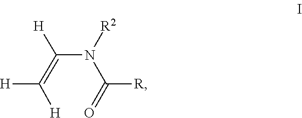

in which R¹ and R², independently of one another, are H or C₁ to C₆ alkyl. Optionally, the water-in-oil inverse suspension polymerization can be performed with one or more additional or optional vinyl monomer(s) which are different from Formula I. Water is then removed, for example azeotropically, from the polymerized product, followed by separating the obtained precipitated N-vinylcarboxamide-containing polymer from the solution or dispersion medium.

The product produced by the polymerization is formed into a granular bead or a micro bead and the water from the produced polymer is removed through, for example, azeotropic distillation. Once the water has been removed the resultant product precipitates and can be physically separated from any dispersion medium and dried through any conventional drying means.

The separated precipitated product can then be hydrolyzed as needed. For example, the product can be transported and hydrolyzed in an aqueous solution of base(s) or acid(s) at a remote location.

Also provided is the composition produced by the polymerization process described above.

### BRIEF DESCRIPTION OF THE DRAWINGS

The present disclosure will hereinafter be described in conjunction with the following drawing figures:

FIG. 1, depicts a graph showing results of drainage performance of a conventional polyvinylamine versus the present technology.

### DETAILED DESCRIPTION

The following detailed description is merely exemplary in nature and is not intended to limit the invention or the application and uses of the invention. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The term “active solids” used for the polymer of the present composition herein represents the total weight of the polymer as a percentage of a solution of all the monomers and modifying compounds used for making the polymer on dry weight basis. The term “mole percent” of a monomer in a polymer refers to percentage of specific monomer present in the polymer as a repeating unit. The term “weight percent” or “weight ratio” of a material used in the present invention represents the percentage or the ratio of the “active solids” of this material versus other components.

As used herein, the term “paper” refers to paper products including tissue paper, paper towels and paper board.

Provided is a method of producing a composition of a N-vinylcarboxamide-containing polymer. The method involves carrying out a water-in-oil inverse suspension polymerization of an aqueous phase containing one or more N-vinylcarboxamide monomer(s) of Formula I;

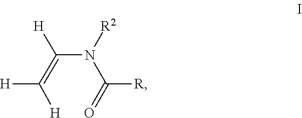

in which R¹ and R², independently of one another are H or C₁ to C₆ alkyl. The polymerized product precipitates from a dispersion medium after water is removed leaving a product comprising an N-vinylcarboxamide-containing polymer. Optionally, the water-in-oil inverse suspension polymerization can be performed with one or more additional or optional vinyl monomer(s) which are different from Formula I. The water from the polymerized product is removed, for example azeotropically, followed by separating the precipitated N-vinylcarboxamide-containing polymer from the dispersion medium.

In some aspects of the method, the starting monomer(s) have a concentration of from about 5 wt. % to about 70 wt. % based on a total weight of all components present during polymerization.

In other aspects of the method, the dispersion medium comprises a water insoluble liquid hydrocarbon.

In other aspects of the method, a polymeric surfactant is used as a dispersion stabilizer in an amount of from about 10 parts per million (ppm) to about 5000 ppm by weight based on the total weight of monomer(s).

In still other aspects of the method, a solution of a water-insoluble hydrocarbon liquid or solvent is used as a dispersion medium in an amount of from about 0.5 to about 20 times the weight of the starting aqueous phase.

In some aspects of the method, polymerization is carried out by radical means, for example by using radical polymerization initiators, for example peroxides, hydroperoxides, so-called redox catalysts or azo compounds which decompose into radicals. Examples for peroxides are alkali or ammonium peroxide sulfates, diacetyl peroxide, dibenzoyl peroxide, succinyl peroxide, di-tert-butyl peroxide, tert-butyl perbenzoate, tert-butyl perpivalate, tert-butyl peroxy-2-ethyl hexanoate, tert-butyl peroxy-2-ethyl hexanoate butyl permaleinate, cumene hydroperoxide, diisopropyl peroxidicarbamate, bis(o-toluoyl) peroxide, didecanoyl peroxide, dioctanoyl peroxide, dilauroyl peroxide, tert-butyl perisobutyrate, tert-butyl peracetate or di-tert-amyl peroxide. An example for hydroperoxide is tert-butyl hydroperoxide. Examples for azo compounds that decompose into radicals are azo-bis-isobutyronitrile, azo-bis-(2-amidonopropane) dihydrochloride, 4,4′-azobis(4-cyanovaleric acid), 2,2′-azobis [2-methyl-N-(2-hydroxyethyl) propionamide], 2,2′-azobis(2-methylpropionamidine) dihydrochloride, 2,2′-Azobis [2-(2-imidazolin-2-yl) propane]dihydrochloride, 2,2′-azobis [N-(2-carboxyethyl)-2-methylpropionamidine]tetrahydrate, 2,2′-azobis [2-(2-imidazolin-2-yl) propane] or 2-2′-azo-bis-(2-methyl-butyronitrile). Examples for so-called redox catalysts are ascorbic acid/ferrous (II) sulfate/sodium peroxodisulfate, tert-butyl hydroperoxide/sodium disulfite, tert-butyl hydroperoxide/sodium hydroxy methane sulfinate, H₂O₂/CuI and combinations thereof.

In some aspects of the method, the inverse suspension polymerization can be carried out using one or more radical initiators used in such processes.

In some aspects of the method, the N-vinylcarboxamide-containing polymer has a molecular weight in the range of from about 5,000 Daltons to about 5,000,000 Daltons, or from about 100,000 Daltons to about 2,000,000 Daltons, or from about 250,000 Daltons to about 750,000 Daltons.

In other aspects of the method, the water is removed or partially removed through azeotropic distillation or other modes of drying commonly used in the industry, to have of final water content 0 wt. % to about 15 wt. % or from 0 wt. % to about 10 wt. % by weight of polymerized product.

In still other aspects of the method, the precipitated N-vinylcarboxamide-containing polymer is in the form of granules, beads, powder, or particles.

In some aspects of the method, the N-vinylcarboxamide monomer(s) is/are selected from N-vinylformamide, N-vinyl-N-methylformamide, N-vinylacetamide, N-vinyl-N-methylacetamide, N-vinyl-N-ethylacetamide, N-vinylpropionamide and N-vinyl-N-methyl-propionamide and N-vinylbutyramide.

Vinyl monomer refers to monomers which have (H₂C═C—) groups in their structure. Vinyl monomers could alternatively be defined as ethylenically unsaturated monomers. An ethylenically unsaturated monomer herein is a monomer containing at least one C₂ unit whose two carbon atoms are linked by a carbon-carbon double bond. In the case of hydrogen atoms as the only substituent, this is ethylene. In the case of substitution with three hydrogen atoms, a vinyl derivative is present. In the case of substitution with two hydrogen atoms, an E/Z isomer, or an ethene-1,1-diylderivative is present. Mono-ethylenically unsaturated monomer means here that exactly one C₂ unit is present in the monomer.

In some aspects of the method, a cationically charged group of a given monomer or class of monomers, salt form means that a corresponding anion ensures charge neutrality. Such anions are for example chloride, bromide, hydrogen sulfate, sulfate, hydrogen phosphate, methyl sulfate, acetate, or formate.

In some aspects of the method, wherein an anionically charged group of a specified monomer or class of monomers, a salt form means that a corresponding cation ensures charge neutrality. Some cations can be, for example cations of the alkali metals, alkaline earth metals, ammonia, alkylamines or alkanolamines, such as Lit, Na⁺, K⁺, Rb⁺, Cs⁺, Mg²⁺, Ca²⁺, Sr²⁺, Ba²⁺ and NH⁴⁺.

In some aspects of the method, the vinyl monomer(s) is/are selected from monoethylenically unsaturated carboxylic acids and their salt forms, monoethylenically unsaturated C₃-C₈ mono- or dicarboxylic acids and their salt forms. Examples are acrylic acid, sodium acrylate, methacrylic acid, sodium methacrylate, dimethacrylic acid, crotonic acid, maleic acid, fumaric acid, itaconic acid, mesaconic acid, citraconic acid, methylene malonic acid, allylacetic acid, vinyl acetic acid, crotonic acid, and combinations thereof.

In some aspects of the method, the vinyl monomer(s) is/are chosen from monoethylenically unsaturated sulfonic acids and their salt forms, vinyl sulfonic acids and their salt forms such as, vinyl phosphonic acid, allyl sulfonic acid, acrylamido-2-methylpropane sulfonic acid, methacrylamido-2-methylpropane sulfonic acid, allylsulfonic acid, methallysulfonic acid, sulfoethyl acrylate, sulfoethyl methacrylate, sulfopropyl acrylate, sulfopropyl methacrylate, 2-hydroxy-3-methacryloxypropyl sulfonic acid, allyl phosphonic acid, styrene sulfonic acid, 2-acrylamido-2-methylpropanesulfonic acid, and combinations thereof.

In some aspects of the method, the vinyl monomer(s) can be chosen from monoethylenically unsaturated phosphonic acids and their salt forms, for example, vinylphosphonic acid, vinylphosphonic acid monomethyl ester, allylphosphonic acid, allylphosphonic acid monomethyl ester, acrylamidomethylpropyl phosphonic acid, acrylamidomethylene phosphonic acid, and combinations thereof.

In other aspects of the method, the vinyl monomer(s) can be selected from monoesters of α,β-ethylenically unsaturated monocarboxylic acids with C₁-C₃₀ alkanols, monoesters of α,β-ethylenically unsaturated monocarboxylic acids with C₂-C₃₀ alkanediols, diesters of α,β-ethylenically unsaturated dicarboxylic acids with C₁-C₃₀ alkanols or C₂-C₃₀ alkanediols, primary amides of α,β-ethylenically unsaturated monocarboxylic acids, N-alkylamides of α,β-ethylenically unsaturated monocarboxylic acids, N,N-dialkylamides of α,β-ethylenically unsaturated monocarboxylic acids, nitriles of α,β-ethylenically unsaturated monocarboxylic acids, dinitriles of α,β-ethylenically unsaturated dicarboxylic acids, esters of vinyl alcohol with C₁-C₃₀ monocarboxylic acids, esters of allyl alcohol with C₁-C₃₀ monocarboxylic acids, N-vinyl lactams, nitrogen-free heterocycles with an α,β-ethylenically unsaturated double bond, vinyl aromatics, vinyl halides, vinylidene halides, C₂-C₈ mono-olefins or C₄-C₁₀ olefins with exactly two double bonds that are conjugated, and combinations thereof.

In some aspects of the method, monoesters of α,β-ethylenically unsaturated monocarboxylic acids with C₁-C₃₀ alkanols can be chosen from, for example, methyl acrylate, methyl methacrylate, methyl ethacrylate (methyl 2-ethyl acrylate), ethyl acrylate, ethyl methacrylate, ethyl ethacrylate (ethyl 2-ethyl acrylate), n-butyl acrylate, n-butyl methacrylate, isobutyl acrylate, isobutyl methacrylate, tert-butyl acrylate, tert-butyl methacrylate, tert-butyl ethacrylate, n-octyl acrylate, n-octyl methacrylate, 1,1,3,3-tetramethyl butyl acrylate, 1,1,3,3-tetramethyl butyl methacrylate, 2-ethylhexyl acrylate, and combinations thereof.

In other aspects of the method, the monoesters of α,β-ethylenically unsaturated monocarboxylic acids with C₂-C₃₀ alkanediols can be chosen from, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutylacrylate, 3-hydroxybutyl methacrylate, 4-hydroxybutylacrylate, 4-hydroxybutyl methacrylate, 6-hydroxyhexyl acrylate, 6-hydroxyhexyl methacrylate, and combinations thereof.

In other aspects of the method, the primary amides of α,β-ethylenically unsaturated monocarboxylic acids can be chosen from, for example, acrylic acid amide, methacrylic acid amide, or a combination thereof.

In still other aspects of the method, N-alkyl amides of α,β-ethylenically unsaturated monocarboxylic acids can be chosen from, for example, N-methylacrylamide, N-methylmethacrylamide, N-isopropylacrylamide, N-isopropylmethacrylamide, N-ethyl acrylamide, N-ethyl methacrylamide, N-(n-propyl) acrylamide, N-(n-propyl) methacrylamide, N-(n-butyl) acrylamide, N-(n-butyl) methacrylamide, N-(tert-butyl) acrylamide, N-(tert-butyl) methacrylamide, N-(n-octyl) acrylamide, N-(n-octyl) methacrylamide, N-(1,1,3,3-tetramethylbutyl) acrylamide, N-(1,1,3,3-tetramethylbutyl) methacrylamide, N-(2-ethylhexyl) acrylamide, N-(2-ethylhexyl-methacrylamide and combinations thereof.

In other aspects of the method, N,N-dialkylamides from α,β-ethylenically unsaturated monocarboxylic acids can be, for example, N,N-dimethylacrylamide, N,N-dimethylmethacrylamide, and combinations thereof.

In other aspects of the method, nitriles from α,β-ethylenically unsaturated monocarboxylic acids can be, for example, acrylonitrile, methacrylonitrile.

In yet other aspects of the method, esters of vinyl alcohol with C₁-C₃₀ monocarboxylic acids can be, for example, vinyl formate, vinyl acetate, vinyl propionate, and combinations thereof.

In other aspects of the method, N-vinyl lactams can be chosen from, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, and combinations thereof.

In other aspects of the method, vinyl aromatics can be, for example, styrene, methylstyrene and combinations thereof. Vinyl halides can be, for example, vinyl chloride, vinyl fluoride, or a combination thereof. Vinylidene halides can be, for example, vinylidene chloride, vinylidene fluoride, and combinations thereof.

In other aspects of the method, C₂-C₈ monoolefins can be, for example, ethylene, propylene, isobutylene, 1-butene, 1-hexene, 1-octene, C₄-C₁₀ olefins with exactly two double bonds that are conjugated, such as butadiene or isoprene, and combinations thereof.

In other aspects of the method the vinyl monomer(s) is/are selected from monoethylenically unsaturated monomer which carries at least one secondary or tertiary amino group and wherein at least one secondary or tertiary amino group is protonated at pH value 7, but which does not carry a group which is deprotonated at pH value 7, or salt form thereof, for example esters of α,β-ethylenically unsaturated monocarboxylic acids with amino alcohols, mono- and diesters of α,β-ethylenically unsaturated dicarboxylic acids with amino alcohols, amides of α,β-ethylenically unsaturated monocarboxylic acids with dialkylated diamines, N-vinylimidazole, vinylpyridine, and combinations thereof.

In some aspects of the method, the vinyl monomer(s) is/are selected from a monoethylenically unsaturated monomer having a quaternized nitrogen as the sole charge bearing group at a pH value of 7, or a salt form of an N-alkyl-N′-vinylimidazolium, a salt form of an N-alkylated vinylpyridinium, a salt form of an acrylamidoalkyl trialkylammonium, or a salt form of a methacrylamidoalkyl trialkylammonium. For example, a salt form of an N-alkyl-N′-vinylimidazolium can be 1-methyl-3-vinylimidazol-1-ium chloride, 1-methyl-3-vinylimidazol-1-ium methyl sulfate or 1-ethyl-3-vinylimidazol-1-ium chloride. For example, a salt form of an N-alkylated vinylpyridinium is 1-methyl-4-vinylpyridin-1-ium chloride, 1-methyl-3-vinylpyridin-1-ium chloride, 1-methyl-2-vinylpyridin-1-ium chloride or 1-ethyl-4-vinylpyridin-1-ium chloride. For example, a salt form of an acrylamidoalkyl trialkylammonium is acrylamidoethyl trimethylammonium chloride (trimethyl-[2-(prop-2-enoylamino)ethyl]ammonium chloride), acrylamidoethyl diethylmethylammonium chloride (diethyl methyl-[3-(prop-2-enoylamino)ethyl]ammonium chloride), acrylamidopropyl trimethylammonium chloride (trimethyl-[3-(prop-2-enoylamino) propyl]ammonium chloride) or acrylamidopropyl diethylmethylammonium chloride (diethyl methyl-[3-(prop-2-enoylamino) propyl]ammonium chloride). For example, a salt form of a methacrylic alkyl trialkylammonium is methacrylamidoethyl trimethylammonium chloride (trimethyl-[2-(2-methylprop-2-enoylamino)ethyl]ammonium chloride), methacrylamidoethyl diethylmethylammonium chloride (diethyl-methyl-[3-(2-methylprop-2-enoylamino)ethyl]ammonium chloride), methacrylamidopropyl trimethylammonium chloride (trimethyl-[3-(2-methyl-prop-2-enoylamino) propyl]ammonium chloride), methacrylamidopropyl diethylmethylammonium chloride (diethyl methyl-[3-(2-methylprop-2-enoylamino) propyl]ammonium chloride).

In some aspects of the method, the vinyl monomer(s) is/are selected from diallyl-substituted amine which has exactly two ethylenic double bonds and is quaternized or protonated at pH 7, or the salt form thereof, for example, diallylamine, methyldiallylamine, diallyldipropylammonium chloride, diallyldibutylammonium chloride and combinations thereof.

In some aspects of the method the vinyl monomer(s) is/are selected from diallyl dimethylammonium chloride, diallyl diethylammonium chloride, or a combination thereof.

In some aspects of the method the vinyl monomer(s) is/are selected from tetraallylammonium chloride, triallylamine, methylenebisacrylamide, glycol diacrylate, glycol dimethacrylate, glycerol triacrylate, pentaerythritol triallyl ether, N,N-divinylethylene urea, tetraallylammonium chloride, polyalkylene glycols esterified at least twice with acrylic acid, methacrylic acid, polyols such as pentaerythritol, sorbitol, and glucose, and combinations thereof.

In some aspects of the method the vinyl monomer(s) can be selected from zwitterionic monomers with phosphobetaine, sulphobetaine, or carboxybetaine functionalities in their structure.

In other aspects of the method, the vinyl monomer(s) can be selected from sulfobetaine 3-(dimethyl(methacryloylethyl) ammonium) propane sulfonate, the sulfobetaine 3-(2-methyl-5-vinylpyridine) propane sulfonate, the carboxy betaine N-3-methacrylamidopropyl-N,N-dimetyl-beta-ammonium propionate, the carboxy betaine N-2-acrylamidoethyl-N,N-dimethyl-beta-ammonium propionate, 3-vinylimidazole-N-oxide, 2-vinyl-pyridine-N-oxide, 4-vinyl-pyridine-N-oxide, and combinations thereof.

In some aspects of the method, the acid component of the esters of α,β-ethylenically unsaturated monocarboxylic acids with amino alcohols can be acrylic acid or methacrylic acid. The amino alcohols can be, for example, C₂-C₁₂ amino alcohols, may be C₁-C₈ mono- or C₁-C₈ dialkylated at the amine nitrogen. Examples are dialkylaminoethyl acrylates, dialkylaminoethyl methacrylates, dialkylaminopropyl acrylates or dialkylaminopropyl methacrylates. Individual examples are N-methylaminoethyl acrylate, N-methylaminoethyl methacrylate, N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, N,N-dimethylaminocyclohexyl acrylate, and N,N-dimethylaminocyclohexyl methacrylate.

In some aspects of the method, the acid component in the mono- and diesters of α,β-ethylenically unsaturated dicarboxylic acids with amino alcohols can be fumaric acid, maleic acid, monobutyl maleate, itaconic acid, crotonic acid, and combinations thereof. The amino alcohols can be C₂-C₁₂ amino alcohols, and may be C₁-C₈ mono- or C₁-C₈ dialkylated at the amine nitrogen.

In some aspects of the method, amides of α,β-ethylenically unsaturated monocarboxylic acids with dialkylated diamines can be, for example, dialkylaminoethylacrylamides, dialkylaminoethylmethacrylamides, dialkylaminopropylacrylamides, dialkylaminopropylacrylamides and combinations thereof.

In some aspects of the method, the amides can be N-[2-(dimethylamino)ethyl]acrylamide, N-[2-(dimethylamino)ethyl]methacrylamide, N-[3-(dimethylamino) propyl]acrylamide, N-[3-(dimethylamino) propyl]methacrylamide, N-[4-(dimethylamino)butyl]acrylamide, N-[4-(dimethylamino)butyl]methacrylamide, N-[2-(diethylamino)-ethyl]acrylamide, N-[2-(diethylamino)ethyl]methacrylamide, and combinations thereof.

In still other aspects of the method, the one or more optional vinyl monomer(s), different from those of Formula I, can be selected from the group of monomers such as, acrylamides, methacrylamides, N-isopropylacrylamides, N-methylmethacrylamides, N-vinylpyrrolidones, acrylonitriles, vinyl acetates, vinyl chlorides, styrene, acrylic acids and salt forms, methacryclic acids and salt forms, vinylphosphonic acids and salt forms, vinylsulfonic acids and salt forms, maleic acids and salt forms, itaconic acids and salt forms, diallyldimethylammonium chloride (DADMAC), acrylamidopropyltrimethyl ammonium chloride (APTAC), methacrylamidopropyltrimethyl ammonium chloride and combinations thereof.

In other aspects of the method, the dried product comprising N-vinylcarboxamide-containing polymer can be hydrolyzed in an aqueous solution of base(s) or acid(s), to produce an aqueous solution of an N-vinylamine containing polymer.

In other aspects of the method, the base denotes an alkali hydroxides, alkali-metal hydroxides, alkaline-earth metal hydroxides, and mixtures thereof.

In some aspects of the method, the N-vinylamine-containing polymer is shipped to a customer location, such as a papermaking plant, and the hydrolysis is carried out at the production site to produce an N-vinylamine-containing polymer.

In other aspects, the N-vinylamine-containing polymer composition described above is added to a pulp suspension in an amount of from about 0.01 wt. % to about 5.0 wt. % based on the dry content of the pulp suspension to produce paper, board, or tissue products.

In yet other aspects, the N-vinylamine-containing polymer can be added to a papermaking process as a dry strength and/or dewatering agent, a coagulant, a flocculant, a retention aid, and a sizing promoter.

Poly(N-vinyl formamide) and its co-polymers can be produced in a granular bead form through an inverse suspension polymerization as follows: The process developed involves a thermal-type polymerization, using a thermal initiator such as V-50 initiator (2,2′-Azobis(2-methylpropionamidine) dihydrochloride) available from FUJIFILM Wako Chemicals USA, Corp. In addition a redox initiator pairing such as tert-butyl hydroperoxide and sodium sulphite can be used in the polymerization process. Aqueous monomer is dispersed in a low boiling hydrocarbon liquid with an added polymeric stabilizer to aid monomer droplet formation solvent and deoxygenated. The contents are then heated to the appropriate temperature, before external heating is removed, redox initiators are added, and adiabatic exothermic polymerization takes place.

The PVFA in dry granular, beaded, powdered, or particulate form can be shipped to the customer site for hydrolysis.

Also provided is a granular, beaded, powdered, or particulate form of PVFA produced by the method described above and the hydrolysis thereof. An aqueous medium is fed into a reactor and heated to a temperature in the range of from about 40° C. to about 95° C., or from about 60° C. to about 80° C. Depending on targeted hydrolysis levels, a pre-determined quantity of base or acid, is added to the reaction mixture. The PVFA is then fed into the reactor along with a predetermined quantity of bisulfite. Once the reaction is completed the pH of the reaction is adjusted in the range of from about 5 to about 9, or a pH of about 6 to about 8 using an appropriate base or acid.

The hydrolyzed product can be used in the manufacture of paper, board, or tissue, for example, as a strength aid, a dewatering aid, a coagulant, a flocculant, a retention agent, and/or sizing promoter.

It is to be appreciated that any or all of the components above (e.g. monomers, modifiers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

The embodiments of the invention are defined in the following Examples. It should be understood that these Examples are given by way of illustration only. Thus, various modifications of the present invention in addition to those shown and described herein will be apparent to those skilled in the art from the foregoing description. Although the method has been described with reference to particular means, materials, and embodiments, it is to be understood that the method is not limited to the particulars disclosed and extends to all equivalents within the scope of the appended claims.

### EXAMPLES

The following examples demonstrate the vinylamine-containing polymers of the current composition provided enhanced drainage and enhanced paper dry strength performance when the compositions are used as additives during the paper making process. These examples and the data presented below better illustrate the benefits of the current composition and are not meant to be limiting.

### Example-1: Synthesis of Poly(N-Vinylformamide) Homopolymer A

The current method utilizes an inverse suspension polymerization for production of a poly(N-vinylformamide) (PVFA) homopolymer in a granular bead form. A 1-liter reactor having a heating source and stirrer was heated to 60° C., at which time 300 grams (g) of hydrocarbon solvent (Exxsol™ D40) and 0.4 milliliter (mL) of a polyacrylate based stabilizer (MUV) were added to the reactor and the mixture stirred and purged under nitrogen for a minimum of 15 minutes. To the reactor, 150 grams of 65% by weight VFA monomer, pre-mixed with 1250 ppm V-50 thermal initiator and 500 ppm sodium sulphite, was added to the mixture while stirring was continued bringing the temperature of the mixture to about 35° C. After a dispersion period of at least 3 minutes, 500 parts-per-million (ppm) tertbutyl hydroperoxide was added to the reactor. The temperature was increased to 90° C. to heat the reaction mixture. To remove the resultant water of the reaction, the contents where then distilled azeotropically. The nitrogen purge was removed, and a vacuum of 85 mbar applied to the system. The contents were then heated to approximately 85° C., over approximately 90 minutes. The resultant product had a bead appearance and was separated from the solvent by decanting and the product subsequently washed with acetone to aid in drying.

### Example-2: Synthesis of Poly(N-Vinyl Formamide) Homopolymer B

The polymer B was synthesized using the same method as in example-1 except, a 50% by weight VFA monomer solution in water premixed with 1250 ppm V-50 thermal initiator and 500 ppm sodium sulphite, was used.

### Example-3: Synthesis of PVFA Homopolymer C

The polymer C was synthesized using same method as in example-2 except for the following: a the VFA monomer solution in water was premixed with 750 ppm V-50 thermal initiator and 300 ppm sodium sulphite was used. In addition, 300 ppm of tertbutyl hydroperoxide was used instead of 500 ppm.

### Example-4: Synthesis of PVFA Copolymer D

In this example, a 70:30 VFA: acrylic acid (wt/wt) polymer was synthesized. First, 22.5 grams 50% pre-neutralized, 50% acrylic acid solution in water was added to a 1-liter reactor and the pH adjusted to a pH of about 6. To the reactor, 26.25 grams VFA monomer and 26.25 grams water was added, followed by 1250 ppm V50 thermal initiator and 100 ppm sodium sulphite. Subsequently, 300 grams solvent Exxsol™ D40 and 0.4 mL polyacrylate based stabilizer (MUV) was added to the reactor that had been pre-heated to 50° C. The mixture was stirred, and the headspace was purged under nitrogen for a minimum of 15 minutes. 150 grams of the pre-mixed monomer solution was added to the reactor under stirring, bringing the temperature of the mixture to about 39° C. After dispersion period of at least 3 minutes, 100 ppm tertbutyl hydroperoxide was added to the reaction mixture. The temperature of the reactor was then increased to 85° C. to heat the reaction mixture. To remove the water from the reaction, the contents where then distilled azeotropically. The nitrogen purge was removed, and a vacuum of 85 mbar applied to the system. The contents were then heated to approximately 85° cover approximately 120 minutes. The resultant polymer product was separated from the solvent by decanting and subsequently washed with acetone to aid in drying. A PVFA in particulate form was obtained.

### Example-5: Synthesis of PVFA Copolymer E

In this example, a polymer labeled Copolymer E, was synthesized using the same method as in Example-4 except, sodium sulphite and tertbutyl hydroperoxide were not added to the reaction. A PVFA in particulate form was obtained.

### Example-6-Hydrolysis of Polymer B to Produce PVAM β-h50

A 250 mL reaction vessel fitted with a condenser, pH and temperature probes, a temperature-controlled heating setup, an addition funnel, and a mechanical stirrer was used. To the reactor, 6.25 grams of Polymer B, 0.15 grams of SMBS, and 135 grams of water were added and heated to a temperature of 80° C. To this mixture, 1.93 grams of NaOH was added. The temperature was kept stable at 80° C. for 180 minutes. Subsequently, the reaction was cooled and neutralized to pH 8 using concentrated hydrochloric acid. The process results in a viscous polyvinylamine polymer, labelled as Polymer β-h50.

### Example-7-Hydrolysis of Product C to Produce PVAM C-h50

Same method as in example-6 was used except the Polymer C was used instead of Polymer B. The process results in a viscous polyvinylamine polymer, labeled as Polymer C-h50.

### Polymer Evaluations

The molecular weights of the PVAM polymers were compared using reduced specific viscosity (RSV). The RSV was determined at 0.20 wt. % in 1 M ammonium chloride using a MINIPV®-HX viscometer available from Cannon® instrument company. A higher RSV indicates higher molecular weight.

The inverse suspension polymerization allows for synthesis of higher molecular weight PVFA polymers compared to PVFA polymers synthesized by conventional solution polymerization. After hydrolysis higher molecular weight PVFA results in higher molecular weight PVAM. The RSV for a polyvinylamine resin (50% hydrolyzed) available from Solenis LLC, was used as a comparative sample (Comparative PVAM-1) and the hydrolyzed polymers Polymer β-h50 and Polymer C-h50, used for further performance evaluation are summarized in Table 1.

TABLE 1
Results from RSV measurements.

| Polymer | RSV |
|---|---|
| Comparative PVAM-1 | 1.9 |
| Polymer B-h50 | 2.5 |
| Polymer C-h50 | 3.6 |

### Evaluation of Strength Properties of Paper Samples

The dry strength of paper samples made with the polyvinylamine (PVAM) polymers from the above examples were compared with the dry strength of paper made with Comparative PVAM-1. Linerboard paper is made using an 8×8 inch² Nobel and Wood hand sheet mold. The paper pulp is a 100% recycled American Old Corrugated Container (AOCC) with 50 ppm hardness, 25 ppm alkalinity, 2.5% GPC D15F and 2000 μS/cm conductivity. The system pH is 7.0 and the pulp freeness is 380-420 CSF. The basis weight is 100 lbs. per 3000 ft2. PVAM polymers prepared in the above examples are added as dry strength additive to the proportioner at the level of 0.1 wt. % and 0.2 wt. % of active polymer versus dry paper pulp. Anionic polyacrylamide is also added at dosage equivalent to the PVAM. Additionally, cationic starch and cationic polyacrylamide retention aids were also added to the proportioner. Ring Crush and STFI were used to measure the effect of PVAM polymers on the dry strength of paper samples.

The dry strength test results are shown below in Table 2. Results of the PVAM polymers are normalized to the results from the control paper made without any PVAM or anionic polyacrylamide. The PVAM Polymer β-h50 and C-h50 from the examples, provided better Ring Crush and STFI performance than the Comparative PVAM-1.

TABLE 2
Results from dry strength evaluation of paper samples.

| | Dosage | Ring | |
|---|---|---|---|
| Polymer | (Wt %) | Crush | STFI |
| Blank | 0 | 100.0 | 100.0 |
| Comparative PVAM-1 | 0.1 | 110.5 | 107.2 |
| Polymer B-h50 | 0.1 | 118.8 | 110.1 |
| Polymer C-h50 | 0.1 | 122.4 | 117.3 |

### Evaluation of Drainage Performance

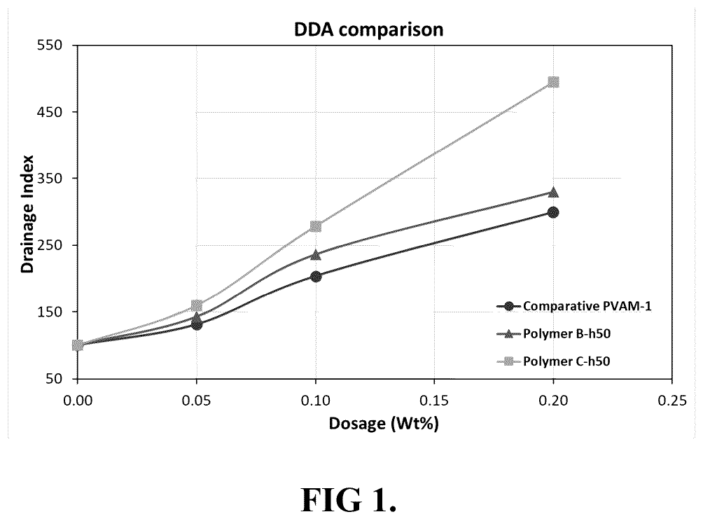

The PVAM polymers were compared for their drainage performance utilizing a Dynamic Drainage Analyzer, test equipment available from AB Akribi Kemikonsulter Sundsvall, Sweden. A 750 milliliter (ml) sample volume at 0.9% consistency and a 0.500 mm opening/0.25 mm thread (32-mesh screen) were used in these tests. The test device applied a 300-mbar vacuum to the bottom of the separation medium and the time between the application of vacuum and the vacuum break point electronically measured, i.e. the time at which the air/water interface passes through the thickening fiber mat. Drainage testing was performed using paper pulp that was 100% American OCC recycled medium with 50 parts-per-million (ppm) hardness, 25 ppm alkalinity, 2.5% GPC D15F oxidized starch (Grain Processing Corp., Muscatine, Iowa) and about 2000-2100 μS/cm conductivity. The system pH was 7.0 and the pulp freeness was about 350-400 CSF for the recycled medium. A drainage index (DI) can be calculated as the drainage time for the control system with no additives divided by the time it takes for the system with additives. Therefore, a higher DI demonstrates an improvement in drainage (FIG. 1).

The drainage performance improves with an increase in molecular weight. The PVAM Polymer β-h50 and C-h50, for examples provided better drainage performance compared to Comparative PVAM-1 (Table 3 and FIG. 1).

TABLE 3
Drainage Index (DI) Results

| Dosage | Comparative | Polymer | Polymer |
|---|---|---|---|
| (Wt. %) | PVAM-1 | B-h50 | C-h50 |
| 0.00 | 100.0 | 100.0 | 100.0 |
| 0.05 | 130.9 | 142.2 | 159.3 |
| 0.1 | 203.6 | 235.8 | 278.1 |
| 0.2 | 299.5 | 329.3 | 494.5 |

While the present compositions and methods of making the compositions and the use of these compositions has been described with respect to particular embodiments thereof, it is apparent that numerous other forms and modifications will be obvious to those skilled in the art. The appended claims should be construed to cover all such obvious forms and modifications which are within the true spirit and scope of the present invention.

We claim:

1. A method of producing a composition of a N-vinylcarboxamide-containing polymer, wherein the method comprises:
performing a water-in-oil inverse suspension polymerization of an aqueous phase containing:
a) one or more N-vinylcarboxamide monomer(s) of Formula I, 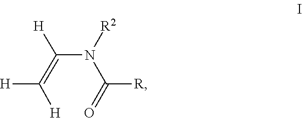
wherein R¹ and R², independently of one another, are H or C₁ to C₆ alkyl; and
b) optionally, one or more vinyl monomer(s) which are different from Formula I,
removing water from the polymerized product whereby the N-vinylcarboxamide-containing polymer precipitates,
separating the precipitate comprising the N-vinylcarboxamide-containing polymer from the dispersion medium.

2. The method of claim 1, wherein the water-in-oil inverse suspension polymerization is performed with an oil phase and an aqueous phase, and wherein monomer(s) have a concentration of from about 10 wt. % to 90 wt. % of the aqueous phase.

3. The method according to claim 1, wherein the water-in-oil inverse suspension polymerization is performed with a dispersion medium as an oil phase, and wherein the dispersion medium comprises a liquid hydrocarbon.

4. The method according to claim 1, wherein the water-in-oil inverse suspension polymerization is performed in the presence of polymeric surfactant(s) present in an amount of from about 10 ppm to 5000 ppm, based on a total weight of monomer(s) in aqueous phase.

5. The method according to claim 1, wherein the water-in-oil inverse suspension polymerization is performed with the amount of dispersion medium 0.5 to 20 times the weight of the aqueous phase.

6. The method according to claim 1, wherein the inverse suspension polymerization is carried out using one or more radical initiators.

7. The method according to claim 1, wherein the N-vinylcarboxamide-containing polymer has a molecular weight in the range of from about 5,000 Daltons to about 5,000,000 Daltons, or from about 100,000 Daltons to about 2,000,000 Daltons, or from about 250,000 Daltons to about 750,000 Daltons.

8. The method according to claim 1, wherein the water is removed or partially removed from the polymerized product through azeotropic distillation and wherein the final water content of the N-vinylcarboxamide-containing polymer is from 0 wt. % to about 15 wt. % or from 0 wt. % to about 10 wt. %.

9. The method according to claim 1, wherein the N-vinylcarboxamide monomer(s) is/are selected from N-vinylformamide, N-vinyl-N-methylformamide, N-vinylacetamide, N-vinyl-N-methylacetamide, N-vinyl-N-ethylacetamide, N-vinylpropionamide and N-vinyl-N-methyl-propionamide and N-vinylbutyramide, and combinations thereof.

10. The method according to claim 9, wherein the N-vinylcarboxamide-containing polymer is a polymer or copolymer of N-vinylformamide.

11. The method according to claim 1, wherein the one or more of the optional vinyl monomer(s) is selected from acrylamide, methacrylamide, N-isopropylacrylamide, N-methylmethacrylamide, N-vinylpyrrolidone, acrylonitrile, vinyl acetate, vinyl chloride, styrene, quaternary ammonium salts of dimethylaminoethyl acrylate (DMAEA), quaternary ammonium salts of dimethylaminoethyl methacrylate (DMAEMA), diallyldimethylammonium chloride (DADMAC), acrylamidopropyltrimethyl ammonium chloride (APTAC), methacrylamidopropyltrimethyl ammonium chloride (MAPTAC); and/or one or more monomers from, acrylic acids, methacrylic acids, itaconic acids, crotonic acids, maleic acids, fumaric acids, 2-acrylamido 2-methylpropane sulfonic acids, vinyl sulfonic acids, vinyl phosphonic acids, allyl sulfonic acids, allyl phosphonic acids, styrene sulfonic acids, water-soluble salts of an alkali metal, water-soluble salts of an alkaline-earth metal, water-soluble salts of ammonium of these monomers, and combinations thereof.

12. The method according to claim 1, wherein the composition of N-vinylcarboxamide-containing polymer is in the form of granules, beads, powder, or particulate.

13. The method according to claim 1, wherein the N-vinylcarboxamide containing polymer is hydrolyzed to a vinylamine containing polymer in an aqueous solution of base(s) or acid(s).

14. An N-vinylamine-containing polymer produced according to claim 1.

15. The N-vinylamine containing polymer according to claim 14, wherein the polymer is added to a pulp suspension in an amount of from about 0.01 wt. % to about 5.0 wt. % based on the dry content of the pulp suspension.

16. The N-vinylamine-containing polymer according to claim 14, wherein the polymer is used in papermaking processes as a dry strength aid, a dewatering agent, a coagulant, a flocculant, a retention aid, and/or a sizing promoter.
